(19) United States
(12) Patent Application Publication
(10) Pub. No.: US 2024/0157636 A1
(43) Pub. Date: May 16, 2024

(54) PRINT HEAD AND METHOD FOR ADDITIVE MANUFACTURING SYSTEM

(71) Applicant: Continuous Composites Inc., Coeur d'Alene, ID (US)

(72) Inventors: Nathan Andrew STRANBERG, Post Falls, ID (US); Andrew John Overby, Coeur d'Alene, ID (US); Stephen Tyler Wilson, Coeur D'Alene, ID (US); Christopher Lee Jones, Post Falls, ID (US); Michael John Milbourne, Dalton Gardens, ID (US)

(73) Assignee: Continuous Composites Inc., Coeur d'Alene, ID (US)

(21) Appl. No.: 18/506,779

(22) Filed: Nov. 10, 2023

Related U.S. Application Data
(60) Provisional application No. 63/383,956, filed on Nov. 16, 2022.

(51) Int. Cl. B29C 64/20; B29C 64/393; B33Y 10/00; B33Y 30/00; B33Y 50/02

(52) U.S. Cl. CPC B29C 64/20; B29C 64/393; B33Y 10/00; B33Y 30/00; B33Y 50/02

(57) ABSTRACT

A system is disclosed for additively manufacturing an object. The system may include a support, and a print head operatively connected to and moveable by the support. The print head may include a first module configured to discharge a material, a second module configured to compact the material, and an actuator connected to the second module and configured to apply a force to the second module. The system may further include a controller in communication with the actuator. The controller may be configured to determine an operating parameter of the print head, and to selectively adjust the force applied by the actuator to the second module based on the operating parameter.

### RELATED APPLICATION

This application is based on and claims the benefit of priority from U.S. Provisional Application No. 63/383,956 that was filed on Nov. 16, 2022, the contents of which are expressly incorporated herein by reference.

### TECHNICAL FIELD

The present disclosure relates generally to a manufacturing system and, more particularly, to a print head and method for an additive manufacturing system.

### BACKGROUND

Continuous fiber 3D printing (a.k.a., CF3D®) involves the use of continuous fibers embedded within material discharging from a moveable print head. A matrix is supplied to the print head and discharged (e.g., extruded and/or pultruded) along with one or more continuous fibers also passing through the same print head at the same time. The matrix can be a traditional thermoplastic, a liquid thermoset (e.g., an energy-curable single- or multi-part resin), or a combination of any of these and other known matrices. Upon exiting the print head, a cure enhancer (e.g., a UV light, a laser, an ultrasonic emitter, a temperature regulator, a catalyst supply, or another energy source) is activated to initiate, enhance, and/or complete curing (e.g., cross-linking and/or hardening) of the matrix. This curing occurs almost immediately, allowing for unsupported structures to be fabricated in free space. When fibers, particularly continuous fibers, are embedded within the structure, a strength of the structure can be multiplied beyond the matrix-only strength. An example of this technology is disclosed in U.S. Pat. No. 9,511,543 that issued to TYLER on Dec. 6, 2016, which is incorporated herein by reference.

Although CF3D® provides for increased strength, compared to manufacturing processes that do not utilize continuous fiber reinforcement, care should be taken to ensure proper steering and compaction of the matrix-coated fibers during and after discharge. Exemplary print heads that provide for at least some of these functions are disclosed in U.S. Patent Application Publication 2021/0260821 that was filed on Feb. 24, 2021 (“the '821 publication”), in U.S. Pat. No. 11,465,348 that was filed on Jul. 26, 2021 (“the '348 patent”), and in U.S. Patent publication 2023/0073782 that was filed on Sep. 2, 2022 (“the '782 publication”), all of which are incorporated herein by reference.

While the print heads of the '821 and '782 publications and the '348 patent may be functionally adequate for many situations, they may be less than optimal. For example, these print heads may lack accuracy in placement and/or precision in compaction. The disclosed print heads, methods and systems are directed at addressing one or more of these issues and/or other problems of the prior art.

### SUMMARY

In one aspect, the present disclosure is directed to a support, and a print head operatively connected to and moveable by the support. The print head may include a first module configured to discharge a material, a second module configured to compact the material, and an actuator connected to the second module and configured to apply a force to the second module. The system may further include a controller in communication with the actuator. The controller may be configured to determine an operating parameter of the print head, and to selectively adjust the force applied by the actuator to the second module based on the operating parameter.

In another aspect, the present disclosure is directed to method of additively manufacturing an object. The method may include discharging a material from a first module of a print head, and moving the print head during the discharging to form the object. The method may also include activating an actuator to compact the material with a second module of the print head, determining an operating parameter of the print head, and selectively adjusting a force applied by the actuator to the second module based on the operating parameter.

### BRIEF DESCRIPTION OF THE DRAWINGS

FIG. 1 is a diagrammatic illustration of an exemplary disclosed additive manufacturing system;

FIG. 2 is a diagrammatic illustration of an exemplary disclosed print head that may be used in conjunction with the system of FIG. 1;

FIG. 3 is a diagrammatic illustrations of an exemplary disclosed compaction module that may be used in conjunction with the print head of FIG. 2;

FIG. 4 is a cross-sectional illustration of an exemplary disclosed portion of the compaction module of FIG. 3;

FIGS. 5 and 6 are diagrammatic illustrations of additional exemplary compaction modules; and

FIG. 7 is a chart depicting an exemplary disclosed method of operating the system of FIG. 1.

### DETAILED DESCRIPTION

The term “about” as used herein serves to reasonably encompass or describe minor variations in numerical values measured by instrumental analysis or as a result of sample handling. Such minor variations may be considered to be “within engineering tolerances” and in the order of plus or minus 0% to 10%, plus or minus 0% to 5%, or plus or minus 0% to 1%, of the numerical values.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

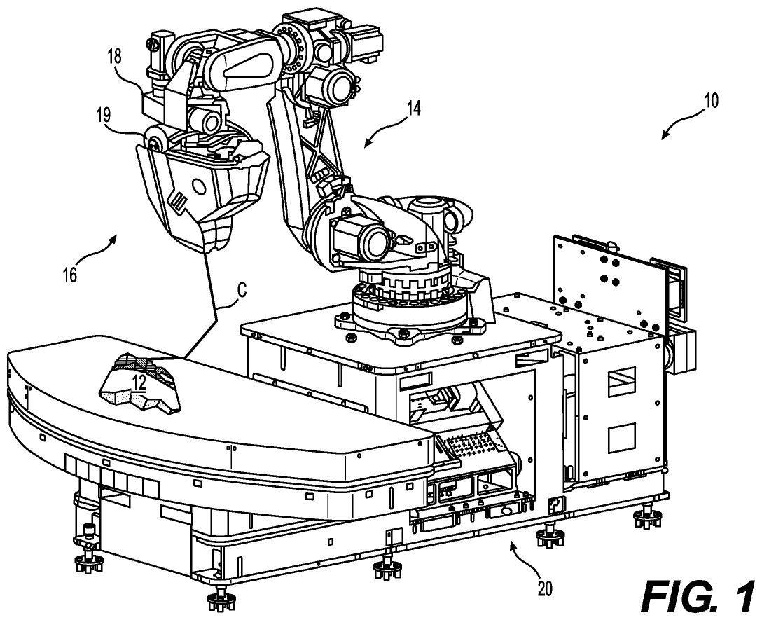

FIG. 1 illustrates an exemplary system 10, which may be used to manufacture a composite structure 12 having any desired shape, size, configuration, and/or material composition. System 10 may include at least a support 14 and a print head (“head”) 16. Head 16 may be coupled to and moveable by support 14 during discharge of a composite material (shown as C). In the disclosed embodiment of FIG. 1, support 14 is a robotic arm capable of moving head 16 in multiple directions during fabrication of structure 12. Support 14 may alternatively embody a gantry (e.g., a floor gantry, an overhead or bridge gantry, a single-post gantry, etc.) or a hybrid gantry/arm also capable of moving head 16 in multiple directions during fabrication of structure 12. Although support 14 is shown as being capable of movements about and/or along six axes, it is contemplated that another type of support 14 capable of moving head 16 (and/or other tooling relative to head 16) in the same or a different manner could also be utilized. In some embodiments, a drive or coupler 18 may mechanically join head 16 to support 14 and include components that cooperate to move portions of and/or supply power and/or materials to head 16.

Head 16 may be configured to receive or otherwise contain a matrix that, together with a continuous reinforcement (e.g., with or without other additives or fillers), makes up the composite material C discharging from head 16. The matrix may include any type of material that is curable (e.g., cross-linkable, hardenable, etc.). Exemplary resins include thermosets, single- or multi-part epoxy resins, polyester resins, cationic epoxies, acrylated epoxies, urethanes, esters, thermoplastics, photopolymers, polyepoxides, thiols, alkenes, thiol-enes, and more. In one embodiment, the matrix inside head 16 may be pressurized, for example by an external device (e.g., by an extruder or another type of pump—not shown) that is fluidly connected to head 16 via a corresponding conduit (not shown). In another embodiment, however, the pressure may be generated completely inside of head 16 by a similar type of device (discussed in more detail below). In yet other embodiments, the matrix may be gravity-fed into and/or through head 16. For example, the matrix may be fed into head 16 (e.g., as a liquid, powder, or solid) and pushed or pulled out of head 16 (e.g., as a liquid) along with one or more continuous reinforcements. In some instances, the matrix inside head 16 may benefit from being kept cool, dark, and/or pressurized (e.g., to inhibit premature curing or otherwise obtain a desired rate of curing after discharge). In other instances, the matrix may need to be kept warm and/or light for similar reasons. In either situation, head 16 may be specially configured (e.g., insulated, temperature-controlled, shielded, etc.) to provide for these needs.

The matrix may be used to coat any number of continuous reinforcements (e.g., separate fibers, tows, rovings, ribbons, socks, sheets and/or tapes of continuous material) and, together with the reinforcements, make up a portion (e.g., a wall, a skin, and/or infill) of composite structure 12. The reinforcements may be stored within (e.g., on one or more separate internal creels 19) or otherwise passed through head 16 (e.g., fed from one or more external spools—not shown). When multiple reinforcements are simultaneously used, the reinforcements may be of the same material composition and have the same sizing and cross-sectional shape (e.g., circular, square, rectangular, etc.), or of a different material composition with different sizing and/or cross-sectional shapes. The reinforcements may include, for example, carbon fibers, vegetable fibers, wood fibers, mineral fibers, glass fibers, metallic wires, optical tubes, etc. It should be noted that the term “reinforcement” is meant to encompass both structural and non-structural types of continuous materials that are at least partially encased in the matrix discharging from head 16.

The reinforcements may be exposed to (e.g., at least partially coated with) the matrix while the reinforcements are inside head 16, while the reinforcements are being passed to head 16, and/or while the reinforcements are discharging from head 16. The matrix, dry reinforcements, and/or reinforcements that are already exposed to the matrix (e.g., pre-impregnated reinforcements) may be transported into head 16 in any manner apparent to one skilled in the art. In some embodiments, a filler material (e.g., chopped fibers, particles, nanotubes, etc.) may be mixed with the matrix before and/or after the matrix coats the continuous reinforcements.

As will be explained in more detail below, one or more cure enhancers (e.g., a UV light, an ultrasonic emitter, a laser, a heater, a catalyst dispenser, a chiller or fan, and/or another source of cure energy) may be mounted proximate (e.g., within, on, or adjacent) head 16 and configured to enhance a cure rate and/or quality of the matrix as it discharges from head 16. The cure enhancer(s) may be controlled to selectively expose portions of structure 12 to the cure energy (e.g., to UV light, electromagnetic radiation, vibrations, thermal changes, a chemical catalyst, etc.) during material discharge and the formation of structure 12. The cure energy may trigger a chemical reaction to occur within the matrix, increase a rate of the chemical reaction, sinter the matrix, harden the matrix, or otherwise cause the matrix to cure as it discharges from head 16. The amount of energy produced by the cure enhancer(s) may be sufficient to cure the matrix before structure 12 axially grows more than a predetermined length away from head 16. In one embodiment, structure 12 is at least partially cured before the axial growth length becomes equal to a cross-sectional dimension of the matrix-coated reinforcement.

The matrix and/or reinforcement may be discharged from head 16 via one or more different modes of operation. In a first exemplary mode of operation, the matrix and/or reinforcement are extruded (e.g., pushed under pressure and/or mechanical force) from head 16 as head 16 is moved by support 14 to create the 3-dimensional trajectory within a longitudinal axis of the discharging material. In a second exemplary mode of operation, at least the reinforcement is pulled from head 16, such that the reinforcement is under tension during discharge. In this mode of operation, the matrix may cling to the reinforcement and thereby also be pulled from head 16 along with the reinforcement, and/or the matrix may be discharged from head 16 under pressure along with the pulled reinforcement. In the second mode of operation, where the matrix is pulled from head 16 with the reinforcement, the tension in the reinforcement may increase a strength of structure 12 (e.g., by aligning the reinforcements, inhibiting buckling, disbursing loading, etc.), while also allowing for a greater length of unsupported structure 12 to have a straighter trajectory. That is, the tension in the reinforcement remaining after curing of the matrix may act against the force of gravity (e.g., directly and/or indirectly by creating moments that oppose gravity) to provide support for structure 12.

The reinforcement may be pulled from head 16 as a result of head 16 being moved by support 14 away from an anchor (e.g., a print bed, a table, a floor, a wall, an existing surface of structure 12, etc.). For example, at the start of structure formation, a length of matrix-impregnated reinforcement may be pulled and/or pushed from head 16, deposited against the anchor, and at least partially cured, such that the discharged material adheres (or is otherwise coupled) to the anchor. Thereafter, head 16 may be moved away from the anchor (e.g., via controlled regulation of support 14), and the relative movement may cause the reinforcement to be pulled from head 16. It should be noted that the movement of reinforcement through head 16 could be assisted (e.g., via one or more internal feed mechanisms), if desired. However, the discharge rate of reinforcement from head 16 may primarily be the result of relative movement between head 16 and the anchor, such that tension is created within the reinforcement. It is contemplated that the anchor could be moved away from head 16 instead of or in addition to head 16 being moved away from the anchor.

A controller 20 may be provided and communicatively coupled with support 14, head 16, and any number of the cure enhancer(s). Each controller 20 may embody a single processor or multiple processors that are specially programmed or otherwise configured via software and/or hardware to control an operation of system 10. Controller 20 may further include or be associated with a memory for storing data such as, for example, design limits, performance characteristics, operational instructions, tool paths, and corresponding parameters of each component of system 10. Various other known circuits may be associated with controller 20, including power supply circuitry, signal-conditioning circuitry, solenoid driver circuitry, communication circuitry, and other appropriate circuitry. Moreover, controller 20 may be capable of communicating with other components of system 10 via wired and/or wireless transmission.

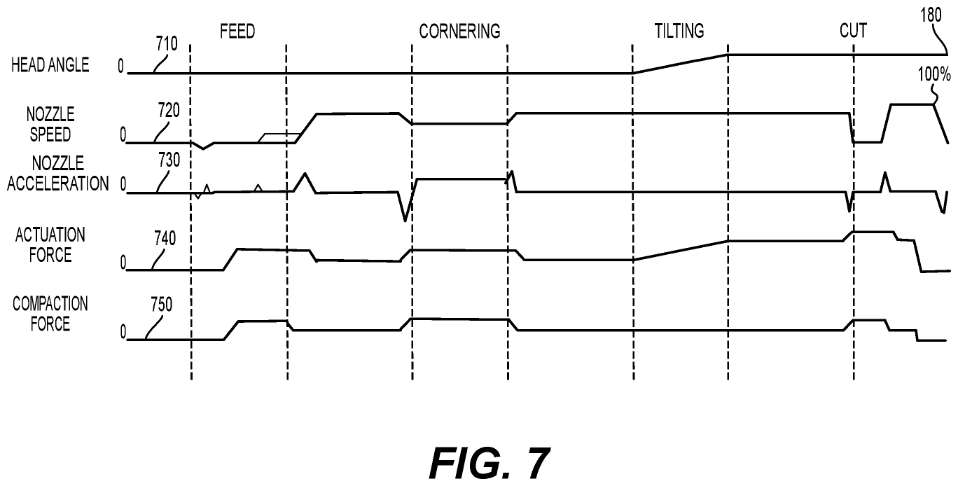

One or more maps may be stored in the memory of controller 20 and used by controller 20 during fabrication of structure 12. Each of these maps may include a collection of data in the form of lookup tables, graphs (see, for example, FIG. 7), and/or equations. In the disclosed embodiment, controller 20 may be specially programmed to reference these maps and determine movements/operations of head 16 required to produce the desired size, shape, and/or contour of structure 12, and to responsively coordinate operation of support 14, the cure enhancer(s), and other components of head 16.

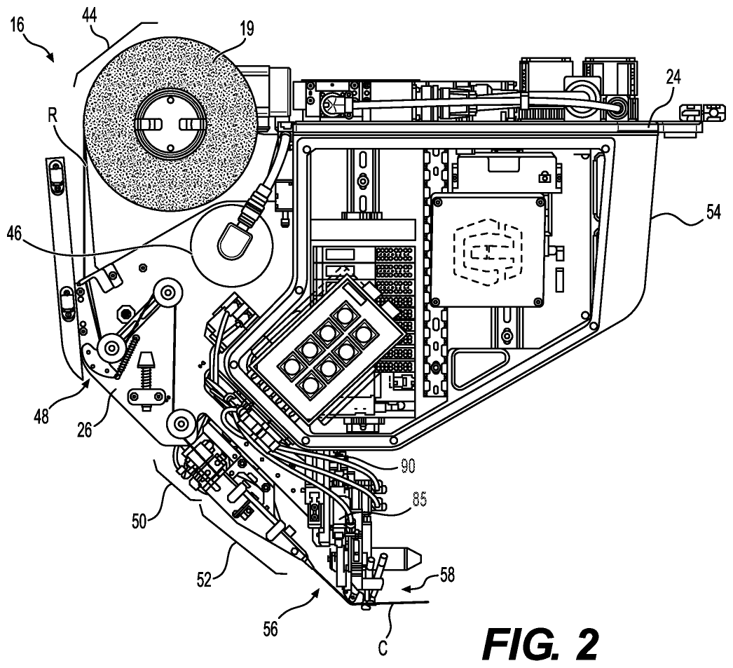

An exemplary head 16 is disclosed in greater detail in FIG. 2. As can be seen in this figure, head 16 may include a mounting arrangement that is configured to hold, enclose, contain, and/or otherwise provide mounting for the remaining components of head 16. The mounting arrangement may include, among other things, an upper generally horizontal plate 24 (e.g., upper as viewed from the perspective of FIG. 2) and one or more generally vertical plates 26 (e.g., lower plates) that intersect orthogonally with upper plate 24. The other components of head 16 may be mounted to a top or bottom of upper plate 24 and/or to a front and/or back of lower plate(s) 26. As will be explained in more detail below, some components may extend downward past a terminal end of lower plate(s) 26. Likewise, some components may extend transversely from lower plate(s) 26 past outer edges of upper plate 24.

Upper plate 24 may be generally rectangular (e.g., square), while lower plate 26 may be elongated and/or tapered to have a triangular shape. Lower plate 26 may have a wider proximal end rigidly connected to a general center of upper plate 24 and a narrower distal end that is cantilevered from the proximal end. Coupler 18 (referring to FIG. 1) may be connected to upper plate 24 at a side opposite lower plate(s) 26 and used to quickly and releasably connect head 16 to support 14. One or more racking mechanisms (e.g., handles, hooks, eyes, etc. —not shown) may be located adjacent coupler 18 and used to rack head 16 (e.g., during tool changing) when head 16 is not connected to support 14.

As shown in FIG. 2, any number of components of head 16 may be mounted to upper and/or lower plates 24, 26. For example, a reinforcement supply module 44, a matrix supply module 46, a tensioning module 48, a clamping module 50, a wetting module 52, a cutting module 56, and a compacting/curing module 58 may be operatively mounted to one or both of upper or lower plates 24, 26. It should be noted that other mounting arrangements may also be possible. As will be described in more detail below, the reinforcement may pay out from module 44, pass through and be tension-regulated by module 48, and thereafter be wetted with matrix in and discharged through module 52 (e.g., as supplied by module 46). After discharge, the matrix-wetted reinforcement may be selectively severed via module 56 (e.g., while being held stationary by module 50) and thereafter compacted and/or cured by module 58.

In some embodiments, the mounting arrangement may also include an enclosure 54 configured to protect one or more components of head 16 from inadvertent exposure to matrix, solvents, dust, debris, and/or other environmental conditions that could reduce usage and/or a lifespan of these components. These protected components may include, among others, any number of conduits, valves, actuators, chillers, heaters, manifolds, wiring harnesses, sensors, drivers, controllers, input devices (e.g., buttons, switches, etc.), output devices (e.g., lights, speakers, etc.) and other similar components.

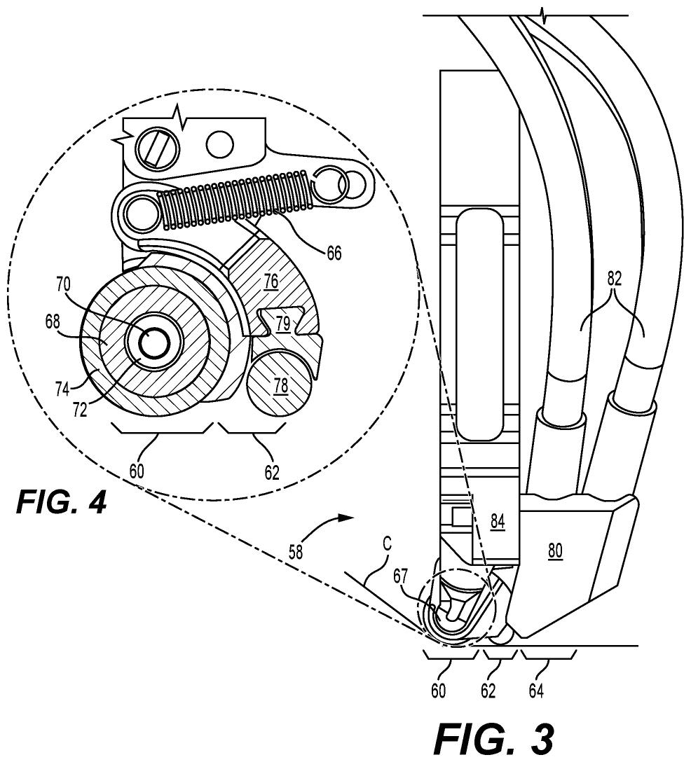

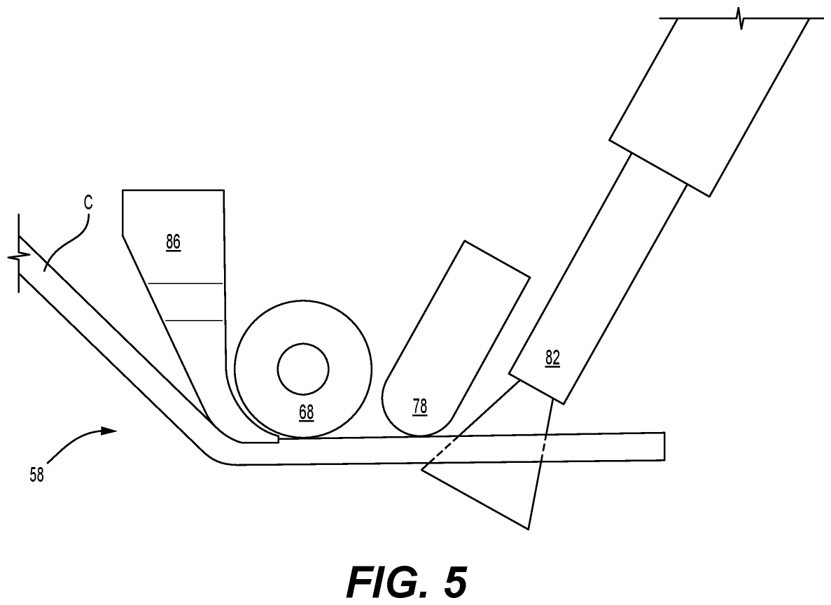

An exemplary module 58 is illustrated in FIG. 3. As shown in this figure, module 58 may be broken down into multiple (e.g., two, three, or more) subassemblies. These subassemblies may include one or more of a leading (i.e., leading relative to a traveling direction of head 16 during normal material discharge and fabrication of structure 12) subassembly 60, one or more of a trailing subassembly 62, and one or more of a curing subassembly 64. As will be explained in more detail below, each of these subassemblies may be connected to each other to form module 58 and move together to compact, wipe over (e.g., smooth, distribute matrix, etc.), and/or cure the material discharging from module 52. For example, subassembly 60 may be rigidly mounted to a leading side of bracket 84 via one or more fasteners (not shown), and subassembly 62 may in turn be pivotally mounted between subassembly 60 and subassembly 64 via one or more additional fasteners (not shown). A spring 66 (shown only in FIG. 4) may extend between subassemblies 60 and 62 to bias subassembly 62 against the discharging material (e.g., downward away from head 16—see FIG. 2). As module 58 is translated downward (i.e., in the perspective of FIG. 4) towards the material, subassembly 62 may be the first to engage the material. Further movement may cause subassembly 62 to pivot upwards (e.g., rotate counterclockwise) against the bias of spring 66 and away from the material, until subassembly 60 also engages the material.

Subassembly 60 may be the first subassembly of module 58 to engage and condition material newly discharging from module 52, relative to the normal travel direction of head 16. As shown in FIG. 4, subassembly 60 may include components that cooperate to move (e.g., roll) over and compact the discharging material. In some applications, the material being discharged may contact subassembly 60 before contacting the surface (e.g., the build platform, a layer of structure 12, etc.) below subassembly 60, and the movement of subassembly 60 may press the discharging material against (e.g., down onto) the surface. In other embodiments, the material may be discharged onto the underlying surface before or at the same time that subassembly 60 contacts the material.

As shown in FIGS. 3 and 4, the components of subassembly 60 may include—among other things—a pair of roller mounts 67 (only one roller mount 67 shown in FIG. 3), a roller 68 mounted (e.g., via a pair of corresponding bearings 72—only one bearing 72 shown in FIG. 4) to opposing stubshafts 70 (only one stubshaft 70 shown in FIG. 4) extending axially inward from mounts 67, and a replaceable wear cover 74 received over an annular surface of roller 68. Roller mounts 67 may be mirrored opposites of each other, each having an outwardly extending pin (not shown) for pivotal mounting of subassembly 62 to subassembly 60, and the corresponding inwardly extending stubshaft 70. Bearings 72 may be pressed onto stub shafts 70 and/or into axial ends of roller 68. Cover 74 may be pressed over roller 68 and provides a generally solid, smooth, and/or slick surface that engages the composite material being discharged and compacted. This may reduce a likelihood of the material picking up a pattern from roller 68 and/or sticking to subassembly 60. Cover 74 may also be an inexpensive and easily replaced wear component that limits damage to the more permanent and expensive roller 68. It is contemplated that cover 74 may be omitted, if desired.

One or more pivot arms 76 may extend from roller mounts 67 (e.g., from the outwardly extending pins) radially rearward to receive a conditioner 78 of subassembly 62. Pivot arms 76 may allow rotation of conditioner 78 (e.g., with or against the bias of spring 66) about roller 68 (e.g., about the pins of roller mounts 67) during engagement of conditioner 78 with the underlying surface. Conditioner 78 may extend laterally between trailing ends of pivot arms 76 and be held in place by one or more fasteners and/or adhesive. Spring(s) 66 may engage leading ends of pivot arms 76 to pull the leading ends rearward toward subassembly 64 and the trailing ends (together with conditioner 78) downward against the underlying surface. In this embodiment, conditioner 78 is smaller (e.g., has a smaller diameter and/or contact surface area) than roller 68, although that may not always be the case (e.g., the sizes may be the same or reversed).

Conditioner 78 may be a cylindrical rolling or non-rolling wiper. It is contemplated that both a roller and a stationary wiper could be utilized together within subassembly 62 (e.g., in series), if desired, and/or that conditioner 78 may not be cylindrical (e.g., conditioner 78 may be cuboid). A mount (e.g., a keyed receiver) 79 may be provided to removably receive conditioner 78 and allow for quick (e.g., snap-out/snap-in) replacement after a period of wear. Conditioner 78, in addition to providing a matrix-smoothing functionality, may also provide a level of compaction to the material and/or shielding of the matrix from cure energy transmitted by downstream components that will be discussed in more detail below. In one embodiment, subassembly 62 provides less compaction (e.g., about 75% less) than subassembly 60. For example, subassembly 62 may provide about 0.75-1.0N (e.g., 0.9N) of compaction, while subassembly 60 may provide about 4.0-5.0N (e.g., 4.4N) of compaction.

Subassembly 64 may include components that cooperate to at least partially cure (e.g., cross-link and/or harden) the discharging material after it has been compacted by subassemblie(s) 60 and/or 62. Subassembly 64 may be configured to only partially cure (e.g., cure sufficient to hold shape) and/or through-cure the matrix within the composite material. As shown in FIG. 3, subassembly 64 may include, among other things, a bracket 80 to which one or more energy transmitters 82 are connected. In the disclosed embodiment, transmitters 82 are light pipes that extend from one or more remote cure sources (e.g., light sources such as lasers, UV lights, etc.) to locations near the composite material being compacted/wiped by subassemblies 60, 62. Transmitters 82 may be held within corresponding bores of bracket 80 via resilient members (e.g., o-rings—not shown) that contract during installation and expand into corresponding annular channels within bores of bracket 80 upon full insertion. The use of these resilient members, as opposed to threaded fasteners, may reduce a likelihood of transmitters 82 being chemically bonded to bracket 80 via excess matrix that has spilled and cured at the interface of transmitters 82 and bracket 80.

In the disclosed embodiment, four energy transmitters 82 (only two shown in FIG. 3) are arranged in left-right and fore/aft pairings (only one of each left/right pairing shown in FIG. 3 that have been oriented in mirrored opposition to each other). Energy transmitters 82 may be the same identical transmitters or different, as desired. The outlets of transmitters 82 may be tilted inward relative to a symmetry plane passing through the composite material C and bracket 80. It is contemplated that the tips of transmitters 82 may additionally or alternatively be tilted forward toward subassembly 62, if desired. Tilting of transmitters 82 toward subassembly 62 may allow for curing closer to conditioner 78, which may increase an accuracy in reinforcement placement. In some embodiments, the trailing transmitters 82 may be tilted by a greater angle than the leading transmitters 82, such that the corresponding areas of exposure of the trailing transmitters 82 on the compacted material overlap at least partially with the areas of exposure generated by the leading transmitters 82. In some applications, the leading transmitters 82 may extend a greater distance in a z-direction (e.g., the vertical direction relative to the perspective of FIG. 3) toward the discharging material compared to the trailing transmitters 82. This may allow for a greater intensity of cure from the leading transmitter 82 and/or a greater area of cure from the trailing transmitter 82. The staggard mounting distance of transmitters 82 may also enhance clearance at the discharge end of head 16, allowing for fabrication within tighter geometrical constraints.

Subassemblies 60-64 may be mounted to move together (e.g., relative to a remainder of head 16), as a single unit. For example, subassemblies 60-64 may be slidably connected to a remainder of head 16 via a bracket 84 (shown in FIG. 3). This mounting arrangement may allow movement of subassemblies 60-64 in a direction generally orthogonal to an underlying print surface and/or relative to the normal travel direction of print head 16 during material discharge. A resilient member (not shown) and/or any number of actuators 85 (only shown in FIG. 2) may be connected to bracket 84 (e.g., between bracket 84 and plate(s) 24 or 26) to bias and/or cause the movement of subassemblies 60-64. It is contemplated, however, that one or both of subassemblies 60, 62 could alternatively or additionally move relative to subassembly 64, if desired.

In some applications, additional guiding of the composite material to and/or away from subassemblies 60-64 may be helpful in improving placement accuracy. That is, unless otherwise accounted for, it may be possible for the composite material to wander in an axial direction of roller 68 and/or conditioner 78 away from a preplanned or target path. This may be particularly true during cornering of print head 16 (i.e., when the depositing material changes trajectory away from a straight-line path), during cutting operations, and/or during feeding operations.

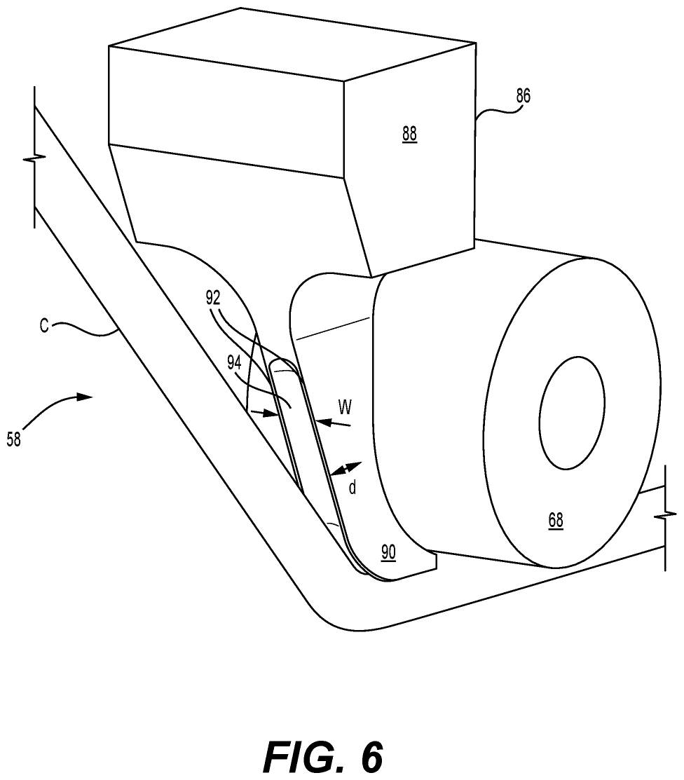

FIGS. 5 and 6 illustrate an example guide 86 that may be placed in close proximity to (e.g., in front of, between, and/or trailing) subassemblie(s) 60 and/or 62. As shown in these figures, guide 86 may include a base end 88 and a distal tip 90. Base end 88 may be directly or indirectly connectable to bracket 84, such that guide 86 moves together with the rest of module 58 (i.e., at least with the one or both of subassemblies 60, 62 that guide 86 is associated with). Tip 90 may extend from base end 88 toward the material passing below module 58. In the disclosed embodiment, tip 90 has a tapering, curving profile. It should be noted, however, that the curving profile could instead be replaced with an inclined linear profile and/or a segmented linear profile (e.g., a profile having multiple linear components, at least one of which is inclined). The curving and/or inclined profile may at least partially surround roller 68 or conditioner 78 (depending on the number and/or arrangement of guide(s) 86) and bring a most distal portion of tip 90 closer to a nip point of roller 68 or conditioner 78 than a remaining portion of guide 86. It is contemplated that tip 90 may have a constant width in the axial direction of roller 68 and/or 70 (i.e., rather than a tapering profile), if desired.

Tip 90 may have a material-facing side, and an opposite side facing either roller 68 or conditioner 78. The material-facing side of tip 90 may be contoured to internally receive only a portion of the material being guided, such that the material is not completely recessed within tip 90 and such that tip 90 does not contact the underlying surface. For example, the material-facing side of tip 90 may include at least one guide feature 92 that protrudes radially outward toward the material and inhibits undesired lateral motion (e.g., motion in an axial direction of roller 68 or conditioner 78) of the material relative to guide 90. In the depicted embodiment, two features 92 are included and spaced apart from each other to engage opposing lateral sides of the material, such that tip 90 straddles the material. In this example, tip 90 may include an annular curved (e.g., concave) surface 94 that extends between features 92. It should be noted, however, that surface 94 need not be curved.

As shown in FIG. 6, the contour of tip 90 at the material-facing side may include a width dimension w between features 92, and a depth dimension d from an outermost edge of feature 90 to an innermost tangent of surface 94. In one example, the width dimension w may be less than a width of the material being discharged by head 16 (e.g., less than a width of an outlet of module 52—referring to FIG. 1). In this same example, the depth dimension d may be less than a thickness of the material (e.g., less than a height of an outlet of module 52—referring to FIG. 1).

As indicated above, module 58 may include any number of guides 86. For example, FIG. 5 illustrates a single guide 86 leading subassembly 60 and associated with roller 68. In this embodiment, tip 90 is oriented rearward relative to a travel direction of head 16, to at least partially wrap around roller 68. It is contemplated, however, that the same or another guide 86 could instead or additionally be located to trail subassembly 60. In this embodiment, tip 90 would be oriented forward in alignment with the travel direction and again at least partially wrap around roller 68.

In yet another embodiment, tip 90 of the same or another guide 86 could instead or additionally be located between subassemblies 60, 62 and oriented rearward to at least partially wrap around conditioner 78. Likewise, the same or another guide could be located to trail conditioner 78 and be oriented in the forward direction. A greater number of guides 68 used within the same module 58 may result in enhanced guiding of the material, albeit at an increased cost and/or complexity of head 16.

It is contemplated that some or all of tip 90 may contact the associated portion of subassemblies 60 and/or 62, if desired. For example, the most distal portion of tip 90 may contact an outer surface of roller 68 (i.e., of cover 74) or conditioner 78. In this embodiment, tip 90 may be shaped (e.g., have a chisel or knife edge) to scrap over the associated surface. This scraping may function to remove unwanted material (e.g., excess matrix, loose fibers, etc.) and/or shape the surface after a period of wear and/or distortion.

A material used to fabricate tip 90 may be important to its functionality and/or longevity. For example, the material may need to be a low-friction material that allows sliding of tip 90 along the corresponding surface of cover 74 and/or conditioner 78 and/or the surface of structure 12, without abrading these surface(s), and also durable such that the sliding does not quickly wear away features 92. In one application, tip 90 may be fabricated from polyoxymethylene (POM), polytetrafluoroethylene (PTFE), and/or fluorinated ethylene propylene (FEP). In another application, tip 90 may be fabricated from aluminum or stainless steel that has been coated, for example, with nickel and/or boron nitride.

FIG. 7 illustrates a control strategy or method for fabricating structure 12 utilizing any of the disclosed embodiments of head 16 and system 10. FIG. 7 will be discussed in more detail below to further illustrate the disclosed concepts.

### INDUSTRIAL APPLICABILITY

The disclosed system and print head may be used to manufacture composite structures having any desired cross-sectional size, shape, length, density, and/or strength. The composite structures may include any number of different reinforcements of the same or different types, diameters, shapes, configurations, and consists, each coated with a common matrix. Operation of system 10 will now be described in detail with reference to FIGS. 1-7.

At a start of a manufacturing event, information regarding a desired structure 12 may be loaded into system 10 (e.g., into controller 20 that is responsible for regulating operations of support 14 and/or head 16). This information may include, among other things, a size (e.g., diameter, wall thickness, length, etc.), a shape, a contour (e.g., a trajectory), surface features (e.g., ridge size, location, thickness, length; flange size, location, thickness, length; etc.) and finishes, connection geometry (e.g., locations and sizes of couplers, tees, splices, etc.), location-specific matrix stipulations, location-specific reinforcement stipulations, compaction requirements, curing requirements, pressure settings, viscosities, flowrates, etc. It should be noted that this information may alternatively or additionally be loaded into system 10 at different times and/or continuously during the manufacturing event, if desired.

Based on the component information, one or more different reinforcements and/or matrices may be selectively loaded into head 16. For example, one or more supplies of reinforcement may be loaded onto creel 19 (referring to FIG. 2) of module 44, and one or more cartridges of matrix may be placed into module 46.

The reinforcements may then be threaded through head 16 prior to start of the manufacturing event. Threading may include passing the reinforcement from module 44 around portions of module 48 and through module 50. The reinforcement may then be threaded through module 52 and wetted with matrix. After threading is complete, head 16 may be ready to discharge matrix-coated reinforcements.

Controller 20 may regulate head 16 to implement a feeding routine. During the feeding routine, modules 50 and 52 may together push a wetted tail of material extending from a nozzle tip of module 52 at least partially under module 58. Module 58 may then be translated to engage the tail (e.g., translated downward in the perspective of FIG. 3 to press the tail against an underlying surface). At least one of subassemblies 60 and/or 62 may apply a pressure to the material, while subassembly 64 exposes the material to cure energy. This may function to anchor the tail.

Once anchoring is complete, module 50 may be deactivated to release the reinforcement, and head 16 may be moved away from the point of anchor to cause the reinforcement to be pulled out of head 16 by the movement. During the movement, the discharging material may be compacted by subassembly 60, wiped over by subassembly 62, and at least partially cured by subassembly 64. This discharge may continue until a target path has been completed and/or until head 16 must move to another location of discharge without discharging additional material during the move.

The component information may be used to control operation of system 10. For example, the reinforcements may be discharged from head 16 (along with the matrix), while support 14 selectively moves head 16 in a desired manner during curing, such that an axis of the discharging material follows a desired trajectory (e.g., a supported or unsupported, 3-D trajectory) along the target path and forms structure 12. Once material has been placed along the target path(s) associated with structure 12, the material may be selectively severed from head 16 via module 56.

During the various operations of head 16 described above, controller 20 may regulate module 58 (e.g., actuator(s) 85 associated with translation of module 58) to selectively vary operation (e.g., actuation and/or compaction force(s)) of subassemblies 60 and/or 62 in coordination with other operations of head 16. Example regulation is shown in FIG. 7.

FIG. 7 illustrates multiple traces depicting different operations of head 16. These traces include a first trace 710 associated with a tilt angle of head 16 relative to the surface on which head 16 is depositing material (e.g., a side-to-side and/or fore/aft tilt of a translation axis of module 58 relative to the underlying surface), a second trace 720 associated with a nozzle speed (i.e., a speed of a tip end of module 52—referring to FIG. 2) in a travel direction of head 16, a third trace 730 associated with a nozzle acceleration, a fourth trace 740 associated with an actuation force applied to module 58 by actuator(s) 85, and a fifth trace 750 associated with a compaction pressure of subassemblie(s) 60 and/or 62 on the underlying substrates as a result of the actuation and gravitational forces. The different operations may include, among other things, a feed operation, a normal discharge operation, a cornering operation, a tilting operation, and a cutting operation.

As can be seen from trace 710, head 16 may generally be maintained in a single orientation (e.g., within engineering tolerances) during most operations (e.g., depending on a contour of structure 12 being fabricated). In one example, this single orientation may be an orientation where the translation axis of module 58 is normal to the underlying surface and in general alignment with gravity, such that gravity assists subassemblie(s) 60 and/or 62 in compacting the material being discharged. In trace 710, this orientation may be considered a zero-degree orientation. In some applications, however, head 16 may need to be tilted in order to properly discharge material along a target path of structure 12 and/or to avoid collisions with structure 12 or surrounding features. In these applications, the further away from the zero-degree position (e.g., away from alignment with gravity) that the translation axis of module 58 becomes, the less that gravity can assist in the compaction and the more that friction within head 16 resists the motion. In fact, if the tilting of head 16 becomes severe enough (e.g., greater than 90°), gravity can actually work against the actuation force applied to module 58 by actuator(s) 85 and reduce the amount of compaction provided by module 58.

As can be seen from trace 720, the speed of the tip end of module 52 may vary throughout operation of head 16. For example, at a start of the feeding operation, module 52 may initially extend a tail end of material protruding from module 52 under module 58—this may be represented by a negative speed or a speed in a direction opposite to a normal travel direction of head 16 (e.g., relative to a travel direction and speed of module 58 or the tool center point—tcp—of head 16). It should be noted that, during this negative speed operation, the composite material may be pushed out of head 16 (e.g., as opposed to being pulled out). Thereafter during the feeding operation, the tip end of module 52 may remain stationary relative to the discharging material (even though the tcp is moving towards the tip end), such that minimal (e.g., no) forces are generated on the material by module 52 during a time that module 58 moves over, compacts and cures the tail end. It should be noted that, even though module 52 may remain stationary during this time, the tcp and the rest of head 16 may be moving in the normal travel direction due to extension of module 52 in a direction opposite the normal travel direction at the same speed as the normal discharge speed. It should be noted that, in alternative applications, the tip end of module 52 may move some during the feeding operation (see dashed line), albeit at a speed still slower than module 58 and the rest of head 16—the slower speed reducing pulling forces on the material that might tend to dislodge the material.

After the tail end has been anchored, the tip end of module 52 may move away from the anchored tail end at the normal discharge speed, such that the material is pulled out of module 52 along a straight-line trajectory. However, it has been found that, in some applications, the normal discharge speed and associated pulling of material out of module 52 may cause adhered portions of the material to dislodge from the underlying surface during cornering (i.e., when the tip end of module 52 is moving along a curving trajectory). Accordingly, the travel speed of the tip end of module 52 may be selectively reduced during a cornering operation to correspondingly reduce tension forces within the material. This may be achieved in several ways, for example by slowing all of head 16 or by selectively extending the tip end toward module 58.

Travel of head 16 (i.e., including the tip end of module 52) may be selectively halted during a severing operation in order to ensure proper severing of the material without causing the material to be dislodged by the severing action. After severing is complete and after deposition of the cut end of the current path has been completed, all of head 16 may be moved at a highest speed from the end of the just completed path of material to a new start location for a next path of material.

As can be seen in trace 730, acceleration of the tip end of module 52 may generally correspond with a change in normalized travel speed. However, it should be noted that a change in trajectory (e.g., during cornering) also results in a change in acceleration, even if the normalized travel speed does not change.

Trace 740 corresponds with the force applied by actuator(s) 85 that causes motion of module 58 and/or that results generally in a force applied by module 58 (Trace 750) on the material being discharged. It should be noted that the force applied to module 58 does not necessary always correspond with the compaction force applied by module 58, due to the effects of gravity and friction (e.g., caused by head tilting) discussed above. Trace 740 may correspond with an actual force exerted by actuator(s) 85, a theoretical force that should be exerted for a given pressure (e.g., air pressure, oil pressure, etc.) directed to actuator(s) 85, and/or a force command directed to actuator(s) 85 by controller 20.

As can be seen in this Traces 740 and 750, the actuation and compaction forces both increase from zero (or even from negative forces holding module 58 away from the underlying surface) to positive values during the feeding operation after the tail end of material has been placed under module 58. In some applications, the actuation and compaction forces may even be higher during the feeding operation than during other (e.g., normal) operations, such that a strong anchor is produced. The higher actuation and compaction forces may remain high until acceleration of module 52 has dissipated, such that the acceleration does result in dislodgement-causing tension.

It has been found that, during cornering, the material being discharged may build up in the z-direction (e.g., due to twisting and/or folding of the material) by an amount greater than in the straight-trajectory areas. One way to keep the height of the material about the same in cornering areas as in the straight-trajectory areas may be to selectively increase the actuation and compaction forces applied to and by module 58 during cornering (see FIG. 7). In some applications, the magnitudes of these forces may increase proportional to a radius of the cornering, wherein higher forces are required for tighter radiuses.

In order to maintain relatively constant compaction pressures during head-tilting operations, the actuation forces applied by actuator(s) 85 may be selectively increased. In some applications, the magnitude of the actuation force increase may be proportional to the tilt angle of head 16 away from alignment with gravity.

It has been found that engagement of module 56 with the material during a cutting operation may transfer forces into the material. If unaccounted for, this transfer of forces could cause the material to dislodge away from the underlying surface and/or be placed inaccurately. Accordingly, as shown in Traces 740 and 750, the actuation and compaction forces may be selectively increased during a cutting operation to ensure that the material remains bonded to the underlying surface at a desired location. After severing of the material, any remaining material downstream of module 56 may be pressed down onto the underlying surface via lower actuation and compaction forces. Thereafter, the forces may be reduced to zero (or even negative values) to lift module 58 away from the material during movement of head 16 to the start of a new path.

As can be seen by a comparison of Trace 750 with Trace 730, a higher compaction force can be applied during a period of acceleration. This higher compaction force may be helpful in reducing dislodgements caused by the acceleration and associated higher levels of tension generated within the material by the acceleration.

In one embodiment, controller 20 may be configured to reference one or more maps stored in memory to regulate the actuation forces applied to and the resulting compaction forces of module 58. For example, the map may include a collection of paths along which material should be deposited to build up structure 12 in a desired manner. Each of these paths may include a starting coordinate, an ending coordinate, and any number of points between these coordinates. Information may also be stored in the map or elsewhere in the memory of controller 20 that correlates a speed for the tip end of module 52, an acceleration rate, a head tilt angle, a path radius, and/or other information with each point and/or path segment between adjacent points. Based on this preprogrammed knowledge about a current and/or ensuing operations, controller 20 may selectively regulate actuator(s) 85 to apply desired levels of force to module 58 during the operation, such that module 58 in turn applies desired levels of compaction pressures to the material. This may be considered a feedforward control strategy.

In another embodiment, controller 20 may responsively adjust the force applied by actuator(s) 85 and the corresponding compaction pressure using a feedback control strategy. For example, controller 20 may receive input from one or more sensors (e.g., an accelerometer, a compaction load cell, a tension sensor associated with the material downstream of module 52, a temperature sensors associated with the material inside of module 52, and/or other sensors known in the art—see FIG. 2) 90 that is indicative of a current operation of head 16, a current applied force, a current tension, a current acceleration, and/or a current compaction force, and responsively adjust operation of actuator(s) 85. For example, in response to an acceleration of module 52 (e.g., an increase in normalized travel speed, a change in direction, etc.) and/or tilting of head 16, controller 20 may selectively cause actuator 85 to increase the force applied to module 58. In another example, in response to an increasing tension within the material (or a parameter associated with increasing tension, like a decreasing resin temperature), controller 20 may cause actuator 85 to increase the force applied to module 58.

In yet another embodiment, controller 20 may implement both the feedforward and feedback control strategies. For example, controller 20 may selectively adjust operation of actuator(s) 85 based on an ensuing operation, and simultaneously monitor actual parameters of head 16 to ensure that the forces applied by actuator(s) 85 result in the desired level of compaction.

It will be apparent to those skilled in the art that various modifications and variations can be made to the disclosed system, print head and method. Other embodiments will be apparent to those skilled in the art from consideration of the specification and practice of the disclosed system, print head and method. It is intended that the specification and examples be considered as exemplary only, with a true scope being indicated by the following claims and their equivalents.

1. A system for additively manufacturing an object, the system comprising:
a support; and
a print head operatively connected to and moveable by the support, the print head including:
a first module configured to discharge a material;
a second module operatively connected to the first module at a trailing location relative to a normal travel direction of the print head and being configured to compact the material discharging from the first module; and
an actuator connected to the second module and configured to apply a force to the second module that causes the second module to press against the material; and
a controller in communication with the actuator and configured to:
determine an operating parameter of the print head; and
selectively adjust the force applied by the actuator to the second module based on the operating parameter.

2. The system of claim 1, wherein the operating parameter includes a tilt angle of the print head.

3. The system of claim 2, wherein the tilt angle is a tilt angle away from a normal of a surface on which the second module is compacting material.

4. The system of claim 2, wherein the tilt angle is measured between a translation axis of the second module and the normal.

5. The system of claim 2, wherein the controller is configured to increase the force applied by the actuator as the tilt angle increases.

6. The system of claim 2, wherein the tilt angle is a tilt angle of a translation axis of the second module away from alignment with gravity.

7. The system of claim 6, wherein the controller is configured to increase the force applied by the actuator as the tilt angle increases.

8. The system of claim 7, wherein the controller is configured to increase the force applied by the actuator such that the second module applies a substantially constant compaction force to the material regardless of a change in gravity assisting movement of the second module.

9. The system of claim 2, further including a sensor configured to generate a signal indicative of the tilt angle, wherein the controller is configured to selectively adjust the force based on the signal.

10. The system of claim 1, wherein the operating parameter is an acceleration of the first module.

11. The system of claim 10, wherein the acceleration is associated with an increased in normalized speed along a straight trajectory.

12. The system of claim 10, wherein the acceleration is associated with a cornering operation.

13. The system of claim 12, wherein the controller is configured to increase the force as a radius of the cornering operation decreases.

14. The system of claim 10, further including a sensor configured to generate a signal indicative of the acceleration, wherein the controller is configured to selectively adjust the force based on the signal.

15. The system of claim 1, wherein the operating parameter is a tension in the material.

16. The system of claim 15, wherein the controller is configured to increase the force as the tension increases.

17. The system of claim 15, further including a sensor configured to generate a signal indicative of the tension, wherein the controller is configured to selectively adjust the force based on the signal.

16. (canceled)

17. (canceled)

18. The system of claim 1, wherein the controller is further configured to:
reference a map stored in memory that relates the parameter to the force; and
selectively adjust the force in a feed-forward manner.

19. The system of claim 18, further including a sensor configured to generate a signal indicative of the parameter, wherein the controller is further configured to selectively adjust the force in a feedback manner based on the signal.

20. A method of additively manufacturing an object, comprising:
discharging a material from a first module of a print head;
moving the print head during the discharging to form the object;
activating an actuator to compact the material with a second module of the print head;
determining an operating parameter of the print head; and
selectively adjusting a force applied by the actuator to the second module based on the operating parameter.

21. The system of claim 1, further including a sensor configured to generate a signal indicative of the parameter, wherein the controller is configured to selectively adjust the force based on the signal.

22. The system of claim 1, wherein the controller is configured to detect curvature of a path on which material is being or is about to be applied, and to responsively increase the force applied to the second module.
